(19) United States
(12) Patent Application Publication
(10) Pub. No.: US 2016/0272786 A1
(43) Pub. Date: Sep. 22, 2016

(54) FLAME-RESISTANT, TEMPERATURE-RESISTANT AND HYDROLYSIS-RESISTANT SUBSTRATES AND USE THEREOF IN ADHESIVE STRIPS FOR AUTOMOTIVE APPLICATIONS

(71) Applicant: TESA SE, Norderstedt (DE)

(72) Inventors: Bernhard MÜSSIG, Seevetal (DE); Michael SIEBERT, Schenefeld (DE); Dennis SEITZER, Eningen unter Achalm (DE)

(73) Assignee: TESA SE, Norderstedt (DE)

(21) Appl. No.: 15/034,061

(22) PCT Filed: Nov. 17, 2014
(86) PCT No.: PCT/EP2014/074717

§ 371 Date: May 3, 2016

(30) Foreign Application Priority Data
Nov. 18, 2013 (DE) 102013223504.6

(51) Int. Cl. C08K 5/523; C09J 7/04; C08K 5/29

(52) U.S. Cl. CPC C08K 5/523; C08K 5/29; C09J 7/04; C09J 133/00

(57) ABSTRACT

Substrate in the form of a flat element comprising a composition containing modified polylactic acid and containing the following components: (1) at least one (co-)polymer based on at least one lactic acid; (2) at least one compound comprising at least one carbodiimide group; (3) optionally at least one compound having at least one epoxide group additionally containing at least one ester group and/or at least one aromatic group; (4) at least one phosphorus-containing compound and (5) optionally additives and/or fillers.

This is a 371 of PCT/EP2014/0747 filed 17 Nov. 2014, which claims foreign priority benefit under 35 U.S.C. 119 of German Patent Application 10 2013 223 504.6 filed 18 Nov. 2013, the entire contents of which are incorporated herein by reference.

The present invention provides a substrate which is simultaneously flame-resistant, temperature-resistant and hydrolysis-resistant and is outstandingly suitable for use in the automobile sector. In particular, the present invention relates to the use of a composition comprising polylactic acid for producing a substrate material, and a substrate formed from the abovementioned composition.

### BACKGROUND OF THE INVENTION

Flame-resistant molded parts from thermoplastic polyesters are described in WO 2004/058869 A2. The flame resistance is achieved by a composition comprising flameproofing agents based on phosphorus, such as resorcinol bis(di-2,6-xylyl)phosphate. (Co)polymers such as PET, PBT and PPT, are employed as thermoplastic polyesters.

WO 2010/012695 A1 discloses biodegradable polyesters based on dicarboxylic acids and dihydroxy compounds, which are more resistant to hydrolysis due to the addition of compounds containing epoxide groups, such as glycidyl acrylate or glycidyl methacrylate. In particular, a copolymer based on styrene and acrylic acid ester and/or methacrylic acid ester is described. Polylactic acid, polyhydroxyalkanoates, polycaprolactone and starch are described as polyesters. Alternatively, WO 2004/069912 A1 describes the increase in the resistance to hydrolysis of aromatic polyesters, such as PBT, by addition of epoxidized natural oils or fatty acid esters.

In U.S. Pat. No. 7,368,493 B2 a compound based on carbodiimide is employed to increase the temperature resistance. This is also said not to result in a change in color of the material.

Nevertheless, in none of the state of the art is a substrate or a composition for producing substrate materials and/or substrates described which meets all three requirements of flame resistance, temperature resistance and resistance to hydrolysis and at the same time is suitable for use in particular on damp bases or in regions of high humidity in the automobile sector.

Biobased or biodegradable polyesters are indeed known, in particular for cable winding tapes in the automobile sector which also have a low combustibility. Thus, polylactic acid is described, for example, in EP 1 932 892 B1 or EP 1 816 174 A2 in the form of nonwovens or films. Nevertheless, it has not hitherto been possible to resolve the disadvantage of the low resistance to hydrolysis of substrates comprising polylactic acid, as a result of which such compositions were hitherto unsuitable for uses under the influence of high humidity in the automobile sector.

### SUMMARY OF THE INVENTION

One object of the present invention is therefore to provide a substrate which simultaneously is flame-resistant, temperature-resistant and hydrolysis-resistant and is suitable for use in regions of high humidity. At the same time it is an aim of the present invention to provide substrates, in particular nonwovens, woven fabric and films, having the properties described above for adhesive tapes and cable winding tapes. It is furthermore an object of the present invention to provide a substrate material, a substrate and adhesive tapes comprising the substrate which comprise components which are as biobased or biodegradable as possible. It is therefore a further aim to provide a substrate, in particular for adhesive tapes, comprising a composition based on biodegradable components, in particular a biodegradable polyester.

The present invention provides a substrate in the form of a planar element including a composition comprising modified polylactic acid and including the components
(1) at least one (co)polymer, in particular (co)polyester, based on at least one lactic acid, in particular a monomer and/or dimer of lactic acid,
(2) at least one compound including at least one carbodiimide group, preferably polymer, including polystyrene-containing polymers, and/or copolymers based on styrene,
(3) optionally at least one compound having at least one epoxide group, additionally containing at least one ester group and/or at least one aromatic group, and
(4) at least one phosphorus-containing compound and
(5) optionally additives and/or fillers.

In order to suppress or to make difficult a biodegradability, the substrate, in particular the planar element in the form of woven fabric, nonwoven or film, can comprise a biocide, in particular a microbicide, such as bactericide or fungicide.

The present invention also relates to the use of a composition comprising modified polylactic acid as a textile substrate material for producing a substrate, as described above, comprising the following components
(1) at least one, preferably biodegradable (co)polymer, in particular (co)polyester, based on at least one lactic acid, in particular a monomer and/or dimer of lactic acid,
(2) a least one compound containing at least one carbodiimide group, preferably a polymer, including polystyrene-based polymers, and/or copolymers based on styrene,
(3) optionally at least one compound having at least one epoxide group, additionally containing at least one ester group and/or at least one aromatic group,
(4) at least one phosphorus-containing compound and
(5) optionally additives and/or fillers.

### DETAILED DESCRIPTION

Additives include antiblocking agents, dyestuffs, optical brighteners, antistatics, antifogging agents, lubricants, UV absorbers, fillers, peeling and/or sealing additives, antioxidants and/or processing auxiliaries. The particular additives can be incorporated already into formulation A, or firstly in formulation B. Furthermore, the film construction according to the invention can comprise at least one additive in one or more film layers or films.

Possible additives are listed by way of example in the following, wherein the selection and function of the particular additives and the influence on the properties are known to the person skilled in the art.
(1) Acid scavengers to increase the stability to hydrolysis. This procedure is preferred above all in the case of polyesters having a high starting acid number. Preferred acid scavengers are, in particular, compounds selected from the group consisting of bisoxazoline, polyoxazoline, carbodiimide, polymeric carbodiimide, dicaprolactam, polymeric caprolactam, bisoxazine and polyoxazine,
(2) lubricants, such as preferably long-chain fatty acids (for example stearic acid or behenic acid), salts thereof (for example Ca or Zn stearate) or montan waxes (mixtures of straight-chain, saturated carboxylic acids having chain lengths of from 28 to 32 C atoms) or salts thereof with alkali or alkaline earth metals, preferably Ca montanate and/or sodium montanate) and low molecular weight polyethylene or polypropylene waxes,
(3) fillers, such as glass fibers,
(4) UV stabilizers, such as various substituted resorcinols, salicylates, benzotriazoles and benzophenones, preferably organic phosphatines, such as, for example, tetrakis(2,4-di-tert-butylphenyl)biphenylene diphosphonite, and/or
(5) coloring agents, such as dyestuffs and inorganic pigments, such as ultramarine blue, iron oxide, zinc sulfide and/or titanium dioxide, furthermore organic pigments, such as phthalocyanines, quinacridones, perylenes and dyestuffs, such as anthraquinones.

The content of the additives is preferably less than 10 wt. % (based on the total composition), further preferably less than 5 wt. %, particularly preferably less than 1 wt. %.

The substrate according to the invention includes planar elements comprising the above composition. In the context of the invention substrates are (a) spun, woven and/or fused planar elements, such as nonwovens, films, woven fabric, mesh fabric, nets, textiles and textile tapes and/or (b) spun, woven and/or fused fiber structures, such as fibers, yarns, stitched fabric, braided fabric, knitted fabric and filaments. The substrates according to the invention can be exclusively planar elements, but equally can be planar elements produced from the (b) fiber structures or a combination of the abovementioned (a) planar elements and (b) fiber structures. Preferred forms of the substrate according to the invention are woven fabrics, nonwovens and films. These include those woven fabrics, nonwovens and films which are employed in cable winding tapes.

The substrates according to the invention are suitable for cable winding tapes, which must meet the main requirements such as

(1) easy to unwind: The product presented in reel form must be easy to unwind for simple processing.
(2) resistance to flagging: Flagging—in the case of an adhesive tape wound around a body—is understood as the tendency of an end of the adhesive tape to protrude. The cause results from the combination of holding force due to the adhesive, the rigidity of the substrate and the diameter of the cable loom. In practice, the ends of the adhesive tape should not become detached by themselves.
(3) cable compatibility: The cable insulation must not become brittle due to the influence of the adhesive tape in combination with elevated temperature over a relatively long period of time. A distinction is made here according to LV 312 (LV 312-1 “Schutzsysteme für Leitungssätze in Kraftfahrzeugen, Klebebänder; Prüfrichtlinie” (10/2009) as a joint standard of Daimler, Audi, BMW and Volkswagen. This standard is abbreviated to LV 312 in the following) between five temperature classes A to E, corresponding to 80° C. (also called temperature class A), 105° C. (also called temperature class B), 125° C. (also called temperature class C), 150° C. (also called temperature class D) and 175° C. (also called temperature class E), which the wrapped cable must withstand for 3,000 h without becoming brittle, in which temperature classes C to E impose higher requirements on the adhesive tape than the lower classes A and B. Both the cable insulation material and the pressure-sensitive adhesive composition and substrate type determine the classification A to E.

Preferably, planar elements according to the invention, in particular in the form of at least one film, nonwoven and/or woven fabric or as a combination, are employed as a substrate in cable and wiring insulations or sheathing, in particular for automobile interior uses.

“Nonwoven” is to be understood as meaning at least textile planar structures according to EN 29092 (1988) and stitch-bonded nonwovens and similar systems. Films, for example, are usually thinner compared with textiles, due to the closed layer they offer additional protection against the penetration of chemicals and operating agents, such as oils, petrol, antifreeze and the like, into the actual cable region, and they can be largely adapted to requirements via the suitable choice of the material. Particularly preferably, the planar element is a textile substrate, preferably a woven fabric, a nonwoven or a knitted fabric or a combination of the forms mentioned. In particular embodiments of the invention with increased requirements of the stability of the planar element, the abovementioned structures can be combined with filament structures, including spun, woven and/or fused fibers, yarns, stitched fabric, braided fabric, knitted fabric and filaments. In particular, nets and diamond-weave fibers are appropriate for example for reinforcing films. Elastomeric and viscoelastic foams having different densities (for example 100 kg/m³ to 900 kg/m³) are furthermore conceivable.

In a particular embodiment the substrates according to the invention, in particular in the form of nonwovens, woven fabrics and/or films, are suitable for adhesive tapes of the forms mentioned above which meet the requirements according to LV 312 on surfaces which become wet only after gluing or in regions of high humidity, in particular in the automobile sector. Damp and/or wet surfaces and/or regions of high humidity include surfaces of high polarity which have adsorbed compounds capable of migration containing at least one hydroxyl group, which can be H₂O, H₂O in the condensed phase, H₂O in vapor form, steam, H₂O in aqueous solution, crystalline H₂O, H₂O in humidity, H₂O in a mixture including oil, H₂O in an emulsion, H₂O in a dispersion, H₂O in fumes, at least one alcohol, an aqueous-alcoholic solution, compound containing at least one hydroxyl group in mixtures with esters and/or mixtures of at least two of the abovementioned components. Such compounds originate from the surrounding medium, in particular liquids, such as aqueous solvents, aqueous mixtures comprising the abovementioned compounds, for example from the engine compartment, such as petrol, engine oil, cooling water, cooling fluid (glycerol, ethanol or ethylene glycol), antifreeze, mixtures, aqueous mixtures comprising gases from the engine compartment which have dissolved, such as exhaust gases, aqueous mixtures comprising particles from the engine compartment, such as abraded material from tires, abraded material from brakes and fine dust and aqueous mixtures, such as, for example, from a car wash lane; furthermore damp air, mist, atmospheric moisture, ice, ice particles, snow and melting water, rain, and mixtures comprising spreading salt and having the abovementioned states of aggregation of water.

The resistance to hydrolysis of the substrates according to the invention, preferably nonwovens, woven fabric and/or films, thus guarantee the mode of functioning of cable tapes, in particular cable winding tapes, in the automobile sector in accordance with LV 312 under the influence of moisture. This likewise applies to uses in regions of high humidity due to the surrounding medium.

Furthermore, the substrate according to the invention has a flame resistance in accordance with the “Combustibility class UL 94 V” specification of at least V-1, preferably V-0.

The temperature resistance of the substrate according to the invention preferably meets at least the requirement B, further preferably C, particularly preferably D.

The substrate, in particular nonwoven, woven fabric and/or film, in the context of the invention fulfils the use spectrum described above due to the composition according to the invention, which according to a further aspect of the invention includes the components in each case with a content, based on the total content of the composition (to 100 wt. %) comprising polylactic acid, of
(1) greater than or equal to 35 wt. %, optionally 25 wt. %, to less than or equal to 98.98 wt. %, greater than or equal to 40 wt. % to less than or equal to 90 wt. %, greater than or equal to 50 wt. % to less than or equal to 85 wt. %, preferably greater than or equal to 60 wt. % to less than or equal to 80 wt. % of the at least one, preferably biodegradable (co)polymer, in particular of the (co)polyester, based on at least one lactic acid, in particular a monomer and/or dimer of lactic acid,
(2) greater than or equal to 0.01 wt. % to less than or equal to 20 wt. %, preferably greater than or equal to 0.1 wt. % to less than or equal to 15 wt. %, greater than or equal to 0.1 wt. % to less than or equal to 10 wt. %, particularly preferably greater than or equal to 0.1 wt. % to less than or equal to 5.0 wt. % of the at least one compound containing a carbodiimide group,
(3) 0 wt. % to less than or equal to 10 wt. %, greater than or equal to 0.01 wt. % to less than or equal to 10 wt. %, preferably greater than or equal to 0.1 wt. % to less than or equal to 7 wt. % of the at least one compound having at least one epoxide group, additionally containing at least one ester group and/or at least one aromatic group, and
(4) greater than or equal to 1 wt. % to less than or equal to 35 wt. %, preferably greater than or equal to 1 wt. % to less than or equal to 25 wt. %, particularly preferably greater than or equal to 5 wt. % to less than or equal to 20 wt. % of the at least one phosphorus-containing compound, and
(5) greater than or equal to 0 wt. % to less than or equal to 10 wt. %, preferably greater than or equal to 0 wt. % to less than or equal to 5 wt. % of additives and/or fillers.

The invention likewise provides the use of the composition according to the invention, wherein the following components are in each case present with a content, based on the total content of the composition (to 10 wt. %) comprising polylactic acid, to the extent of
(1) greater than or equal to 35 wt. %, optionally 25 wt. %, to less than or equal to 98.89 wt. %, greater than or equal to 40 wt. % to less than or equal to 90 wt. %, greater than or equal to 50 wt. % to less than or equal to 85 wt. %, preferably greater than or equal to 60 wt. % to less than or equal to 80 wt. % of the at least one preferably biodegradable (co)polymer, in particular of the (co)polyester, based on at least one lactic acid, in particular a monomer and/or dimer of lactic acid,
(2) greater than or equal to 0.01 wt. % to less than or equal to 20 wt. %, preferably greater than or equal to 0.1 wt. % to less than or equal to 15 wt. %, greater than or equal to 0.1 wt. % to less than or equal to 10 wt. %, particularly preferably greater than or equal to 0.1 wt. % to less than or equal to 5.0 wt. % of the at least one compound containing a carbodiimide group,
(3) 0 wt. % to less than or equal to 10 wt. %, greater than or equal to 0.1 wt. % to less than or equal to 10 wt. %, preferably greater than or equal to 0.1 wt. % to less than or equal to 7 wt. % of the at least one compound having at least one epoxide group, additionally containing at least one ester group and/or at least one aromatic group, and
(4) greater than or equal to 1 wt. % to less than or equal to 35 wt. %, preferably greater than or equal to 1 wt. % to less than or equal to 25 wt. %, particularly preferably greater than or equal to 5 wt. % to less than or equal to 20 wt. % of the at least one phosphorus-containing compound, and
(5) greater than or equal to 0 wt. % to less than or equal to 10 wt. %, preferably greater than or equal to 0 wt. % to less than or equal to 5 wt. % of additives and/or fillers.

In the context of the invention the substrate thus includes at least one monomer and/or dimer of lactic acid, compounds selected from the group of L(S)-lactic acid, D(R)-lactic acid, (S,S)-lactide, (R,R)-lactide, (meso)-lactide and mixtures of at least two of the compounds mentioned. By using the abovementioned compounds substrates are preferably achieved, in particular the planar element in the form of a woven fabric, nonwoven or film.

The invention furthermore provides a use of the composition according to the invention comprising modified polylactic acid as a textile substrate material for producing a substrate, wherein (1) at least one biodegradable (co)polymer is a polyester based on (a) at least one monomer and/or dimer of lactic acid selected from L(S)-lactic acid, D(R)-lactic acid, (S,S)-lactide, (R,R)-lactide and (meso)-lactide and mixtures of at least two of the compounds mentioned. In particular, polymers such as poly(L)-lactide, copolymers, such as poly(D,L)-lactide and poly(L)-lactide-co-(D,L)-lactide, are preferred. Preferably, the polymer used has a melt flow index WI (190° C., 2.16 kg) of from 0.5 to 50 g/10 min.

Lactic acid is a hydroxycarboxylic acid having a carboxyl group and a hydroxyl group. It can be present in various isomers, L(S)-lactic acid and D(R)-lactic acid, which in the context of the invention are understood as monomers. D-Lactic acid is described as levorotatory and L-lactic acid as dextrorotatory. R is a synonym for D and S is a synonym for L. Racemates are mixtures of the two isomers with a ratio of 1:1.

Lactide is a cyclic diester of lactic acid and in the context of the invention is understood as meaning a dimer of lactic acid. Analogously to the monomers, dimers can likewise be present as various isomers (S,S)-lactide, (R,R)-lactide and (meso)-lactide. The lactide of L-lactic acid (synonym=(S)-lactic acid) has an (S,S) configuration, that is to say is present as (S,S)-lactide, and the lactide of D-lactic acid (synonym=(R)-lactic acid) has an (R,R) configuration, that is to say is present as (R,R)-lactide. (meso)-Lactide consists of an L- and D-lactic acid and is consequently an (R,S)-lactide and has two centers of asymmetry with the opposite R and S configuration.

Polymers in the context of the invention are preferably polyesters and include homopolymers of one of the abovementioned compounds based on lactic acid and copolymers including at least two of the lactic acid derivatives mentioned. Homopolymers based on lactic acid are, for example, polyesters of L-lactic acid poly(L)-lactide and of the racemate D,L-lactic acid poly(D,L)-lactide and copolymers are, for example, polyesters of L-lactide with D-lactide, such as poly(L)-lactide-co-(D)-lactide or L-lactide with D,L-lactide, such as poly(L)-lactide-co-(D,L)-lactide.

In a particular embodiment the copolymer of lactic acid can include as a (b) second monomer a compound selected from the group including (i) aliphatic and aromatic mono/dicarboxylic acids, such as valeric acid (=butylcarboxylic acid), succinic acid (succinate), malic acid, adipic acid, maleic acid, alpha-, beta-hydroxy acids, terephthalic acid, lactic acid, glycollic acid, butyric acid (beta), hydroxyvaleric acid, mevalonic acid and/or (ii) alpha-, omega-diols containing alkyl groups, including 1,2-, 1,3-, 1,4-alkyl-diols including ethyl, propyl, butyl, preferably 1,4-butanediol, 1,3-propanediol and mixtures of at least two of the compounds mentioned.

Possible copolymers of lactic acid are, for example, poly(L)-lactide-co-glycollide and poly(D,L)-lactide-co-glycollide. By copolymerization of the lactic acid with glycollic acid lactide the degradation of the polyester in the substrate, in particular woven fabric, nonwoven or film, over time can be controlled since the degradation of the polyester is slowed down by glycollic acid. By the mixing ratio of the two acids or their lactones, the desired degradation or the life of the substrate material, in particular the film, can be adjusted accordingly.

Preferably, the substrates according to the invention, in particular woven fabric, nonwovens and films, comprise at least one polyester as a homopolymer of polylactic acid (PLA), for example Compostable® from Cereplast, Ecopond PLA-873 from Kingfa, Bio-Flex® A4100 CL from FKuR, FT1 from Minima, all Ingeo products from NatureWorks, Kareline® from Plasthill, all Natureplast products and PLA from RTP. Bio-Flex from FKuR Kunststoff GmbH, Biocycle from Klöckner Pentaplast GmbH & Co. KG, Biofront from Teijin Chemicals Ltd., Biopearls from Biopearls, Biophan from Treofan Germany GmbH & Co. KG, Ceramis from Alcan Packaging Kreuzlingen GmbH, Earthfirst from Sidaplax V.O. F., Ecodear from Toray Industries, Inc., Ecovio from BASF SE, Fozeas from Mitsubishi Chemical Corporation, Ingeo from NatureWorks LLC, Lacea from Mitsui Chemicals, Terramac from Unitika Ltd, Jackdraw from Jackdraw Polymers, Polyvel from Polyvel Inc., Hycal from Hycal BV, Lactel from Durect.

In a particular embodiment the substrate according to the invention includes in its composition a combination of at least two polymers, in particular polyesters. Preferably, the composition includes, in addition to one of the homopolymers of polylactic acid described above, a further component (1.1) which is at least one polymer and is selected from the group including
(a) polymers including polyethylene terephthalate (PET), polytrimethylene terephthalate (PTT), polybutylene terephthalate (PBT), polyamide (PA), polyurethane (PU), polybutyl succinate (PBS), polyhydroxyalkanoate, polylactic acid (PLA) and its copolymers, scPLA, PPLA, polycaprolactone and starch and/or
b) copolymers based on at least one fatty acid, including substituted, unsubstituted polyhydroxy-fatty acids or polyhydroxyalkanoates (PHA), such as polybydroxybutyrate (PHB), polyhydroxyvalerate (PHV), polyhydroxybutyrate-co-hydroxyvalerates (PHVB) and polyhydroxybutyrate-co-hydroxyhexanoate (PHBH).

A further aspect of the invention is thus the use of a composition comprising polylactic acid as a substrate material, in particular for a substrate, preferably in the form of a woven fabric, nonwoven and/or film, preferably for adhesive tapes and cable winding tapes in automobile uses, wherein the substrate material additionally includes a (1.1) further component. This (1.1) component is preferably at least one polymer of the type described above.

Preferably, according to the invention a composition comprising polylactic acid is used as a substrate material for producing a substrate in which a combination of PLA with at least one further, preferably biodegradable polymer is present.

Preferred, preferably biodegradable polyester mixtures comprise, based on the total content of the sum of all the polymers (1) and further components (1.1) (to 100 wt. %) in the composition according to the invention:

With a content of greater than or equal to 30 wt. % to less than or equal to 70 wt. %, preferably greater than or equal to 35 wt. % to less than or equal to 65 wt. %, of a polyester based on lactic acid, preferably a polylactic acid homopolymer, and with a content of less than or equal to 70 wt. % to greater than or equal to 30 wt. %, preferably less than or equal to 65 wt. % to greater than or equal to 35 wt. % of one or more polymers selected from group (a) and/or (b) of the further (1.1) polymers, preferably polyhydroxyalkanoates (PHA), starch and polycaprolactone (PCL). Preferred polylactic acids are, for example, NatureWorks® 4020 or 4042D (polylactic acid from NatureWorks).

Polyhydroxyalkanoates (PHA) are primarily to be understood as meaning poly-4-hydroxybutyrate and poly-3-hydroxybutyrate, furthermore copolyesters of the abovementioned hydroxybutyrates with 3-hydroxyvalerate or 3-hydroxyhexanoate are included. Poly-3-hydroxybutyrate-co-4-hydroxybutyrate is known in particular from Metabolix. They are marketed under the trade name Mirel®. Poly-3-hydroxybutyrate-co-3-hydroxybutyrate is known from P&G or Kaneka. Poly-3-hydroxybutyrate is marketed, for example, by PHB Industrial under the brand name Biocycle® and by Tianan under the name Enmat®. The polyhydroxyalkanoates as a rule have a molecular weight Mw of form 100,000 to 1,000,000 and preferably from 300,000 to 600,000. Polycaprolactone is marked by Daicel under the product name Placcel®. Starch is understood as meaning non-modified starch and also cereals and cellulose as well as starch rendered thermoplastic with plasticizers, such as, for example, glycerol or sorbitol.

Further possible combinations, without making a limitation, are PLA+PHA, PLA+PHB, PLA+PHV, PLA+PHBV or PLA+PTT, PLA+PBS, PLA+PA, PLA+PU, PLA+PET, PLA+PBT. It is of course possible for more than two polyesters to be mixed, wherein at least PLA is present in the use according to the invention. Any combination which can be used as a substrate material according to the invention is conceivable. In particular, such a substrate material which is suitable for substrates in the context of the invention, preferably substrates in the form of planar elements, such as woven fabric, nonwovens and films.

Examples of further suitable biobased polyesters are listed in the following without making a limitation:

Polyhydroxy-fatty acid or polyhydroxyalkanoates (PHA): PHBV from TianAn Biopolymer: ENMAT Y1000, ENMAT Y1010, ENMAT Y1000P, ENMAT Y3000, ENMAT Y3000P and ENMAT F9000P (PHBV/PLA); Biomer (PHB) from Biomer, Biocycle (PHB) from PHB Industrial Brasil S.A.; Mirel and Mvera from Teiles (PHA), Progenic from Propper GmbH & Co. KG; Nodax (PHBH) from P&G Chemicals
PCL (polycaprolactones): Capa from Perstorp UK Limited, Caprowax P from Polyfea
PBS: Bionelle 1000 from Showa Denko K.K., Bionelle 3000 (PBSA=polybutylene succinate-co-adipate)
Mixtures: Ecopond from Kingfa Science and Technology Co. Ltd.; Aonilex from Kaneka Corp.

Preferred fiber mixtures, in particular for woven fabric and/or nonwovens, preferably in nonwovens, include fiber mixtures of

(a) PLA fibers and PET fibers,
(b) PLA fibers and PPL fibers,
(c) PLA fibers and scPLA fibers,
(d) PLA fibers and PPL fibers and PET fibers, or
(e) PLA fibers and scPLA fibers and PET fibers

And preferred fiber mixtures are

(f) PLA fibers and cellulose acetate and/or cellophane or
(g) PLA fibers and starch and/or paper.

In a preferred embodiment the substrate according to the invention in the form of a planar element and the substrate material including a composition comprising modified polylactic acid for producing the substrate according to the invention includes the following components
(1) at least one polyester based on polylactic acid of the type described above,
(2) at least one compound containing a carbodiimide group, which is an aliphatic compound containing a carbodiimide group, preferably having an isocyanate as the terminal group, or a compound containing a terminal end group having a hydroxyl group, in particular having a degree of polymerization of at least 5,
(3) at least one compound having at least one epoxide group, additionally containing at least one ester group and/or at least one aromatic group, which is selected from
   (3.1) epoxidized copolymers based on styrene and/or
   (3.2) epoxidized fatty acid esters,
      and
(4) at least one phosphorus-containing compound, which is selected from
   (4.1) inorganic phosphorus-containing compounds including red phosphorus, aluminum- and zinc-phosphatine salts, and/or
   (4.2) organic phosphorus-containing compounds including phosphates, oligomeric and polymeric phosphates and
(5) optionally additives and/or fillers.

The (2) compound containing a carbodiimide group in the context of the invention fulfils the function of imparting to the substrate material according to the invention and the substrate according to the invention, in particular the woven fabric, nonwoven and film, the required temperature resistance. In this context a content of at least 0.01 wt. % of the compound containing a carbodiimide group is necessary, since at amount below this limit no improvement in the resistance to hydrolysis can be achieved. In particular in the case of polymers containing ester groups, in particular biobased and/or biodegradable polyesters, such as polylactic acid, a content of at least 0.01 wt. % of the compound containing a carbodiimide group is necessary in order to improve the stability to hydrolysis. It is to be taken into account that above a content of 5 wt. % a discoloration of the material may occur. If this is undesirable, not more than 5 wt. % of the compound containing a carbodiimide group should be employed.

By using a substrate material comprising carbodiimide groups of the composition described herein a substrate material, in particular a substrate for adhesive tapes and cable winding tapes for automobile uses, having good temperature resistance is thus achieved.

Compounds having at least one carbodiimide group in the molecule are used as compounds containing a carbodiimide group. These are prepared by processes known in the state of the art in which, for example, polyisocyanate is produced by decarboxylation and condensation with organic phosphorus compounds in the presence of a catalyst (for example phosphorus oxides and alkoxides of titanium, hafnium and zirconium) (see, for example, U.S. Pat. No. 2,941,956 A, JP 47 033 279 B, J. Org. Chem., 28, 2,069 to 2,075 (1963) and Chemical Review 1981, vol. 81, no. 4, p. 619 to 621). Preferred compounds as the starting material for the preparation of polycarbodiimide include aromatic diisocyanates, aliphatic diisocyanates, linear diisocyanates and mixtures thereof. In particular, organic diisocyanates include 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, mixtures of 2,4-tolylene diisocyanate and 2,6-tolylene diisocyanate, hexamethylene diisocyanate, cyclohexane 1,4-diisocyanate, xylylene diisocyanate, isophorone diisocyanate, dicyclohexylmethane 4,4′-diisocyanate, methylcyclohexane diisocyanate, tetramethylxylylene diisocyanate, 2,6-diisopropylphenyl isocyanate and 1,3,5-triisopropylbenzene 2,4-diisocyanate.

If a polycarbodiimide is used as compounds containing a carbodiimide group, this has an isocyanate as a terminal group if the polymerization reaction is quenched or stopped, for example, by cooling. To control the degree of polymerization by addition of terminal groups on to the polycarbodiimides, for example, compounds such as phenyl isocyanate, tolyl isocyanate, dimethylphenyl isocyanate, cyclohexyl isocyanate, butyl isocyanate and naphthyl isocyanate are employed.

Alternatively, other terminal groups can be introduced, such as, for example, by (i) aliphatic, aromatic and/or linear compounds having a hydroxyl group, such as, for example, methanol, ethanol, phenol, cyclohexanol, N-methylethanolamine, polyethylene glycol monomethyl ether and polypropylene glycol monomethyl ether, (ii) diethylamines and dicyclohexylamines containing at least one NH group, (iii) butylamines and cyclohexylamines containing at least one NH₂ group (iv) succinic acid, benzoic acid and cyclohexanol acid having a COOH group, (v) ethylmercaptan, allylmercaptan and thiophenol having an SH group, (vi) compounds having epoxide groups, (vii) acetic anhydride, methyltetrahydrophthalic anhydride and methylhexahydrophthalic anhydride.

The compound containing a carbodiimide group interacts with the polyester of the substrate material according to the invention. In particular, hydrogen bridge bonds are formed between the molecules. In this context the hydrogen bridge bonds are formed by interaction between the ester groups of the polyesters, in particular the hydroxyl and/or carboxyl groups, and the reactive nitrogen of the carbodiimide group. A network of hydrogen bridge bonds thereby forms between the individual polyester molecules, as a result of which the substrate material is stabilized. For this purpose 4,4′-dicyclohexylmethanecarbodiimides (degree of polymerization 2 to 20, preferably 5 to 15), tetramethylxylylenecarbodiimide (degree of polymerization 2 to 20, preferably 5 to 15), N,N-dimethylphenylcarbodiimide (degree of polymerization 2 to 20, preferably 5 to 15) and N,N′-di-2,6-diisopropylphenylcarbodiimide (degree of polymerization 2 to 20, preferably 5 to 15) are preferably used.

Preferably, aliphatic polycarbodiimides having a degree of polymerization of at least 5 are used, in order to ensure a temperature resistance of the substrate material according to the invention. Particularly preferably, the aliphatic polycarbodiimide has an isocyanate as an end group, as a result of which a high resistance to hydrolysis is achieved. Aliphatic polycarbodiimides are preferred over aromatic polycarbodiimides, since these ensure a better resistance to hydrolysis and temperature resistance.

The compounds described above containing at least one carbodiimide group are particularly well-suited for polymers of lactic acid, in particular polyesters of lactic acid as homopolymers and/or copolymers of lactic acid or the dimer lactide with maleic acid, succinic acid and its derivatives, such as malic acid or glycollic acid. In this context the carbodiimide groups interact with the carboxylic acid and hydroxyl groups of the polyesters.

Preferably, the compound described above containing a carbodiimide group is used with poly(L)-lactide, wherein polymers of the D isomer and meso isomer of the lactide and copolymers of the lactides mentioned are equally well-suited. Preferably, the polymer includes in all cases 90 wt. % of one of the lactic acid derivatives mentioned. In a particular embodiment of the composition according to the invention of the substrate material, and therefore of the substrate, polycarbodiimide, as the compound containing a carbodiimide group, is preferably used in combination with PLA, as a result of which the temperature resistance of the substrate, in particular in the form of a planar element, such as a woven fabric, nonwoven and film, is improved.

The present invention furthermore provides that the substrate (3) includes at least one compound having at least one epoxide group, additionally containing at least one ester group and/or at least one aromatic group. This compound is selected from
(3.1) at least one epoxidized copolymer, including styrene and acrylic acid ester, styrene and methacrylic acid ester or mixture of the two copolymers, which independently preferably include at least one glycidyl acrylate and/or glycidyl methacrylate as the epoxide group, and/or
(3.2) at least one epoxidized fatty acid ester, including (i) natural oils selected from olive oil, linseed oil, palm oil, groundnut oil, coconut oil, tung oil, rapeseed oil, castor oil and cod liver oil, and the fatty acids thereof present, preferably soy bean oil, preferably the tri-fatty acid glycerides present having at least 18 C atoms, and (ii) fatty acid esters, including esters of saturated or unsaturated aliphatic carboxylic acids having 10 to 40 C atoms, preferably carboxylic acids having 16 to 22 C atoms, with aliphatic saturated alcohols having 2 to 40 C atoms, alcohols preferably having 2 to 6 C atoms.

The present invention also provides the use of a compound having at least one epoxide group, additionally containing at least one ester group and/or at least one aromatic group in the composition comprising polylactic acid which is used as a substrate material for producing the substrate according to the invention.

The (3.1) epoxidized copolymer in the context of the invention is explained in more detail in the following.

Glycidyl (meth)acrylates are used as units carrying epoxide groups. Copolymers of which the content of glycidyl methacrylate present is greater than or equal to 20 wt. %, particularly preferably greater than or equal to 30 wt. % and particularly preferably greater than or equal to 50 wt. % of the copolymer are preferred. The epoxide equivalent weight (EEW) in these polymers is preferably 150 to 3,000 and particularly preferably 200 to 500 g/equivalent. The average molecular weight (weight-average) Mw of the polymers is preferably 2,000 to 25,000, in particular 3,000 to 8,000. The average molecular weight (number-average) Mₙ of the polymers is preferably 400 to 6,000, in particular 1,000 to 4,000. The polydispersity (Q) is in general between 1.5 and 5. Such copolymers are available, for example, as Joncryl® ADR from BASF Resins B.V. Joncryl® ADR 4368, long-chain acrylates and Cardura® E10 from Shell are particularly suitable as a chain lengthener. Copolymers of the abovementioned type containing epoxide groups are employed with a content of greater than or equal to 0.1 wt. % to less than or equal to 5 wt. %, preferably greater than or equal to 0.1 wt. % to less than or equal to 2 wt. %, and particularly preferably greater than or equal to 0.2 wt. % to less than or equal to 1 wt. %, based on the (1) (co)polymer.

In the context of (3.2) epoxidized fatty acid esters those compounds of which the epoxide groups are not bonded terminally (so-called epoxide groups located “internally” in the hydrocarbon chain) are used in the substrate material according to the invention. The content of epoxide groups in the particular compound is preferably greater than or equal to 1 wt. % to less than or equal to 20 wt. %, preferably from greater than or equal to 4 wt. % to less than or equal to 15 wt. % and in particular from greater than or equal to 6 wt. % to less than or equal to 12 wt. %, based on the epoxidized compound in the context of (3.2). If such a compound is used in the substrate material, the composition according to the invention comprising polylactic acid comprises greater than or equal to 0.01 wt. % to less than or equal to 10 wt. %, preferably greater than or equal to 0.5 wt. % to less than or equal to 7 wt. % and particularly preferably greater than or equal to 1 wt. % to less than or equal to 5 wt. % of at least one of the compounds described above.

Of the natural oils proposed, including olive oil, linseed oil, palm oil, groundnut oil, coconut oil, tung oil, rapeseed oil, castor oil, cod liver oil or mixtures thereof, linseed oil and soy bean oil are particularly preferred. The molecular weight of such oils is preferably from 500 to 1,000, particularly preferably from 600 to 900. Such linseed oils or soy bean oils are mixtures of tri-fatty acid glycerides, wherein the content having a carbon chain of 18 C atoms predominates. The epoxidized fatty acid esters can in general be prepared from these natural oils by methods familiar to the person skilled in the art.

In the context of epoxidized fatty acid esters, esters of saturated or unsaturated aliphatic carboxylic acids having 10 to 40 C atoms, preferably 16 to 22 C atoms, with aliphatic saturated alcohols having 2 to 40 C atoms, preferably 2 to 6 C atoms, are used in the substrate material according to the invention. The carboxylic acids can be mono- or dibasic. Examples of such saturated carboxylic acids which may be mentioned are pelargonic acid, palmitic acid, lauric acid, margaric acid, dodecanedioic acid, behenic acid, montanic acid, particularly preferably stearic acid, capric acid and, as unsaturated carboxylic acids, linoleic acid, linolenic acid and oleic acid.

The aliphatic alcohols can be mono-, di-, tri- to tetrahydric. Examples of alcohols are n-butanol, n-octanol, stearyl alcohol, ethylene glycol, propylene glycol, neopentyl glycol, pentaerythritol, myricyl alcohol and cetyl alcohol, wherein glycerol is preferred as a trihydric alcohol.

Mixtures of various esters and/or oils can also be employed. Preferably, the ester in the context of (3.2) comprises unsaturated fatty acid contents corresponding to an iodine number (according to DIN 53995) of from 130 mg to 180 mg and in particular from 120 mg to 200 mg of iodine per gram of substance.

The introduction of the epoxide function into the abovementioned oils and/or esters is carried out via reaction of these with epoxidizing agents, for example per-acids, such as peracetic acid. Such reactions are known to the person skilled in the art.

The use of a compound according to (3.1), according to (3.2) or a combination of at least two of the compounds mentioned of the groups described in the substrate material according to the invention leads to a higher resistance to hydrolysis of the substrate material and therefore of the substrate obtainable from the substrate material. The resistance to hydrolysis is accompanied by an increased viscosity and an improved shear stability of the substrate material according to the invention. The copolymers containing epoxide groups react here, with branching and chain lengthening, with the processed polyester fragments formed by thermal or hydrolytic degradation. This leads on the one hand to an increased molecular weight, but also on the other hand to a decrease in functional end groups, such as, for example, carboxyl end groups.

In the context of the invention the substrate and the composition comprising modified polylactic acid comprise (4) at least one phosphorus-containing compound selected from
(4.1) inorganic phosphorus-containing compounds including red phosphorus, aluminum- and zinc-phosphatine salts, and/or
(4.2) organic phosphorus-containing compounds including phosphates, oligomeric and polymeric phosphates, oligomeric and aromatic phosphate esters
   and mixtures comprising at least two of the compounds mentioned.

Compounds which are employed as (4.2) organic compounds containing a phosphate group in the context of the invention are those which are preferably selected from aliphatic esters of phosphoric acid, including tris(chloroethyl) phosphate (TCEP), tris(chloropropyl) phosphate (TCPP), tris(dichloroisopropyl) phosphate (TDCPP) and the particular derivatives thereof, and/or aromatic esters of phosphoric acid, including triphenyl phosphate (TPP), tris(2-ethylhexyl) phosphate (TEHP), tricresyl phosphate (TKP), isopropylated triphenyl phosphate (ITP), including mono-, bis- and tris(isopropylphenyl) phosphate, resorcinol bis(diphenyl)phosphate (RDP) and bisphenol A bis(diphenyl)phosphate (BDP) and the particular derivatives thereof.

Preferably, the substrate according to the invention comprises a content of greater than or equal to 1 wt. % to less than or equal to 35 wt. %, greater than or equal to 1 wt. % to less than or equal to 25 wt. %, greater than or equal to 5 wt. % to less than or equal to 20 wt. % of at least one phosphorus-contain compound. In particular, a composition comprising polylactic acid and comprising a compound according to (4.1), according to (4.2) or a combination of at least two compounds of the compounds mentioned is used as the substrate material for producing substrates.

At a content of less then 5 wt. % a flame resistance of V-0 according to the test of combustibility class UL 94 V is not usually achieved. If a content of greater than 25 wt. % is employed, this has an adverse influence on the mechanical properties of the substrate material and therefore of the substrate.

Preferred are oligomeric aromatic phosphate esters, in particular according to formula (I):

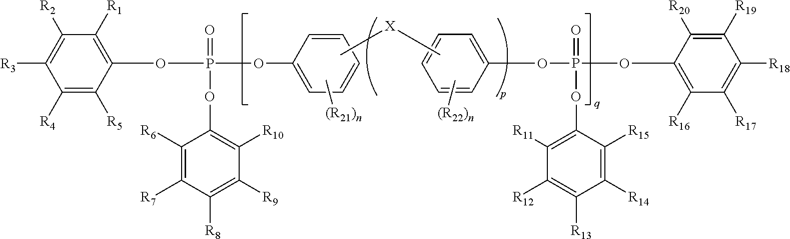

(I) wherein R1 to R22 independently hydrogen or an alkyl group having 1 to 4 C atoms, for example methyl, ethyl, n-propyl, i-propyl, or tert.-butyl; X is a bond —CH₂—, —C(CH₃)₂—, —S—, —SO₂—, —O—, —CO— or —N═N—; n is 0, 1, 2, 3, or 4; p is 0 or 1; and q is an integer between 1 and 16 inclusive.

A particularly preferred oligomeric aromatic phosphate ester is resorcinol bis(di-2,6-xylyl)phosphate, in particular having the structure according to formula (II), and other preferred aromatic phosphate esters, in particular according to formula (III) and (IV).

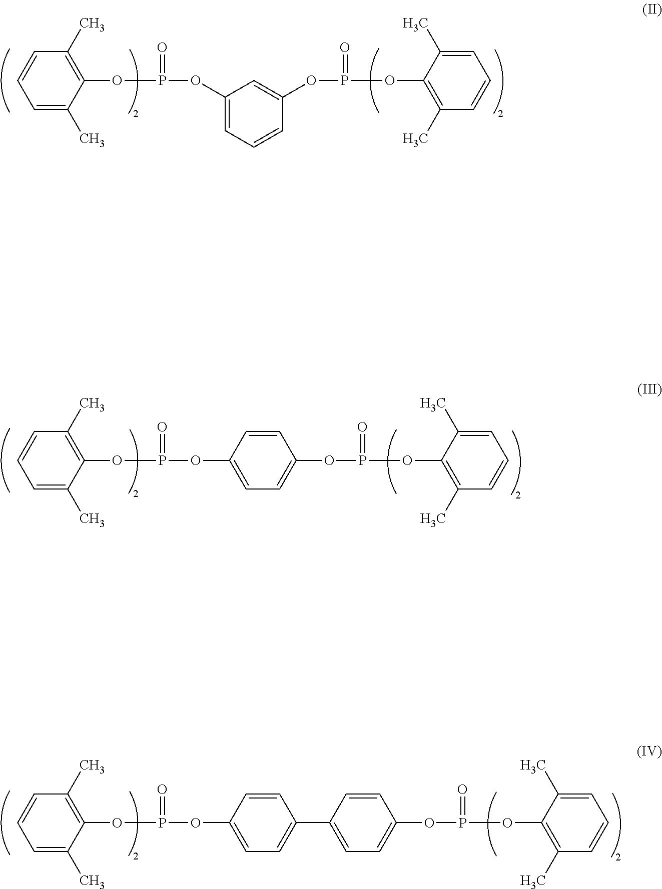

Inorganic or preferably organic compounds are selected as phosphorus-containing flameproofing agents (E). Examples are ammonium polyphosphate, ethylenediamine polyphosphate and phosphoric acid and phosphonic acid esters, such as, for example, triphenyl phosphate, tricresyl phosphate, alkylphenyl phosphates, diphenyl cresyl phosphate.

Particularly preferably is hydrocarbyl (dihydrocarbylphosphates) of the general formula

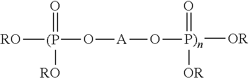

wherein R is preferably an aryl group (for example phenyl, cresyl), A is a bonding group, such as arylene (for example phenylene), biarylene (for example biphenyl), two arylene groups which are bonded by a further group, such as —CH2-, —C(CH3)2-, —SO2- or —CO—, or alkylene (for example neopentyl), and n is between 1 and 10. Such compounds are prepared on a large industrial scale from phosphoric acid or phosphorus oxytrichloride and diphenols, such as resorcinol or bisphenol A (which then form the group A) and monophenols, such as phenol and cresol (which then form the group R). Phosphoric acid 1,3-phenylene-tetraphenyl ester and phosphoric acid 1,3-phenylene-tetraphenyl ester oligomers and bisphenol A bis-(diphenyl phosphates) and oligomers thereof become preferred.

Phosphoric acid derivatives and phosphonic acid derivatives which liberate neither phenol nor cresol during hydrolysis become very particularly preferred, and examples of these are trixylyl phosphate, butylated triphenyl phosphates (for example Fyrquel™ EHC-S), phosphoric acid 1,3-phenylene-tetraxylenyl ester and salts of phosphonic acids, such as sodium, magnesium, zinc or aluminum salts of propane- or phenylphosphonic acid (benzenephosphonic acid).

Nitrogen compounds can have a synergistic action to phosphorus-containing flameproofing agents, and suitable nitrogen-containing flameproofing agents (F) are therefore melamine cyanurate, melamine, biuret, triuret, ammelides, ammelines, cyanuric acid, tris(2-hydroxyethyl) isocyanurate, bis(2-hydroxyethyl) isocyanurate, 2-hydroxyethyl isocyanurate, tris(carbomethyl) isocyanurate, tris(2-cyanoethyl) isocyanurate, bis(2-cyanoethyl) isocyanurate, 2-cyanoethyl isocyanurate, trimethyl isocyanurate, HA(L)S, such as CAS no. 40601-76-1 or 27676-62-6 or 34137-09-2 or 129757-67-1 or 191680-81-6, melam, meiem, dicyandiamide, guanidines, biguanidines, triphenyl isocyanurate or tricresyl isocyanurate. The preferred nitrogen-containing flameproofing agent is melamine cyanurate.

Possible phosphorus- and nitrogen-containing flameproofing agents (G) are compounds which contain both elements, such as, for example, melamine phosphate, melamine polyphosphate, urea phosphate, diethyl N,N-bis(2-hydroxyethyl)aminomethylphosphonate, N,N-bis(2-hydroxyalkyl)aminomethanephosphonic acid dimethyl ester, triethanolamine phosphate or phosphorus oxytriamide.

### Further DODP-Based Flameproofing Agents:

The compound comprises 9,10-dihydro-9-oxa-10-phosphaphenanthrene 10-oxide (DOPO) or a reaction product of DOPO and a further compound in which the H of the P—H bond is replaced by an organic radical, the amount is preferably 5 to 40 phr. Catalysts, such as boric acid or imidazole derivatives, can optionally be employed. The reaction can take place, for example, as an addition reaction (for example DOPO with acrylonitrile, quinone, itaconic acid or acrylic acid ester) or condensation reactions (for example with alkylated phenolic resins or formaldehyde resins, such as dimethylolbenzoguanamine). DOPO or reaction products thereof can be added to the polyurethane or incorporated into the polyurethane.

### EXAMPLES

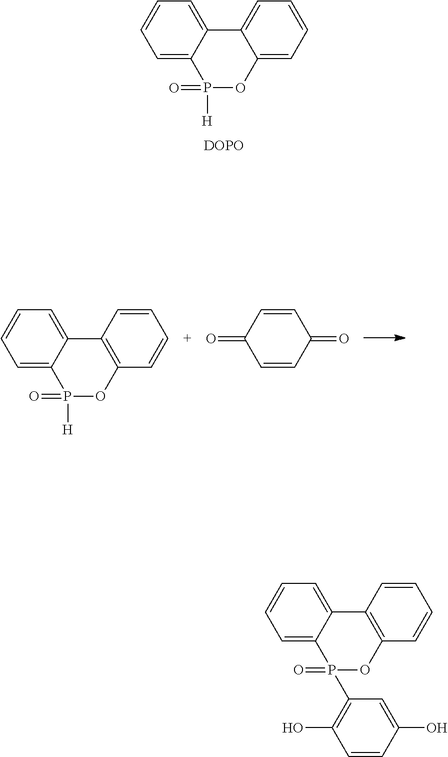

### Reaction Product of DOPO and Quinone

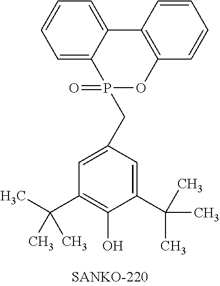 [SMILES: CC(C)(C)c1cc(CP2(=O)Oc3ccccc3-c3ccccc32)cc(C(C)(C)C)c1O]

### Reaction Product of DOPO and Ionox™ 100

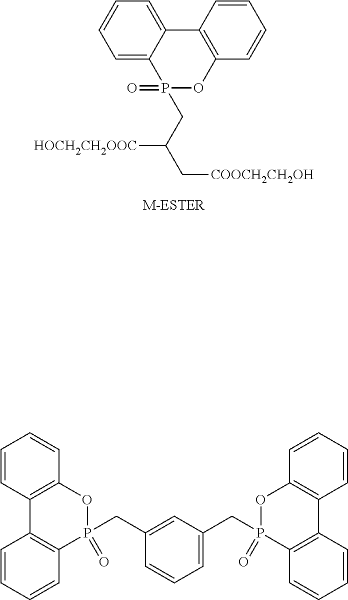

### Reaction Product of DOPO and Butylated Formaldehyde Resin (Phenodur™ VPR 1785)

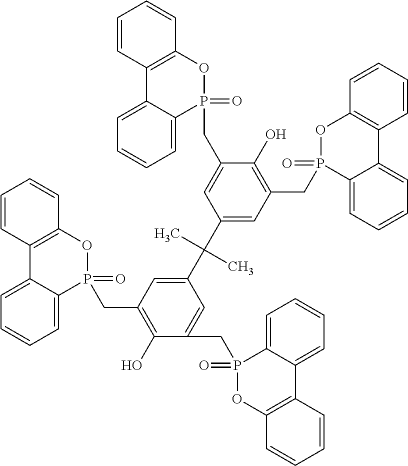 [SMILES: CC(C)(c1cc(CP2(=O)Oc3ccccc3-c3ccccc32)c(O)c(CP2(=O)Oc3ccccc3-c3ccccc32)c1)c1cc(CP2(=O)Oc3ccccc3-c3ccccc32)c(O)c(CP2(=O)Oc3ccccc3-c3ccccc32)c1]

### Reaction Product of DOPO and a Butylated Bisphenol A-Formaldehyde Resin (Phenodur™ PH 411)

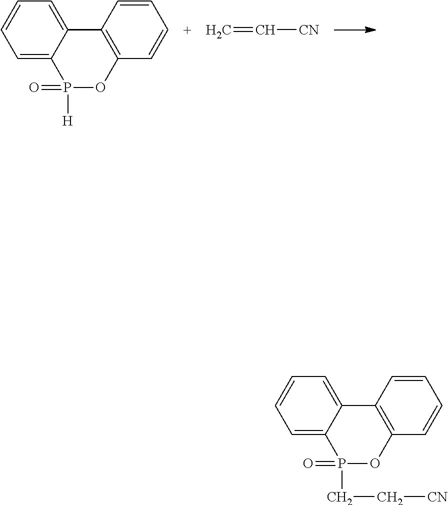

### Reaction Product of DOPO and Acrylonitrile

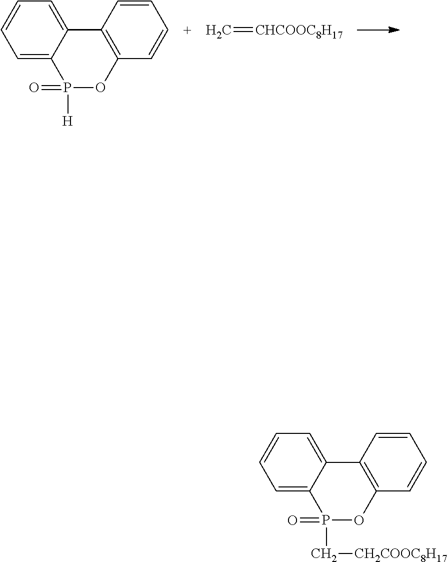

### Reaction Product of DOPO and Octyl Acrylate

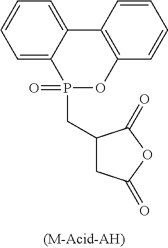 [SMILES: O=C1CC(CP2(=O)Oc3ccccc3-c3ccccc32)C(=O)O1]

### M-Ester-HP (polyester of butanedioic acid and (6H-dibenz[c,e][1,2]oxaphosphorin-6-ylmethyl) bis-(2-hydroxyethyl) P-oxide

Preferred embodiments of the substrate material including a composition comprising modified polylactic acid for producing the substrate according to the invention are

### Substrate Material A (Composition A=to 100 wt. %)

(1) PLA with a content of greater than or equal to 43.8 wt. %, preferably 70 wt. %, to less than or equal to 88.8 wt. %,
(1.1) PHBV with a content of greater than or equal to 10 wt. % to less than or equal to 30 wt. %,
(2) polycarbodiimide with a content of greater than or equal to 0.1 wt. % to less than or equal to 0.7 wt. %,
(3) epoxidized copolymer of styrene with acrylic acid ester with a content of greater than or equal to 0.1 wt. % to less than or equal to 0.5 wt. %,
(4) aromatic phosphate ester with a content of greater than or equal to 1 wt. % to less than or equal to 25 wt. %, preferably of greater than or equal to 5 wt. % to less than or equal to 25 wt. % and
(5) optionally additives and/or fillers.

### Substrate Material B (Composition B=to 100 wt. %)

(1) PLA with a content of greater than or equal to 43.8 wt. %, preferably 70 wt. %, to less than or equal to 88.8 wt. %,
(1.1) PHA (PHB, PHBV and/or PHBH) with a content of greater than or equal to 10 wt. % to less than or equal to 30 wt. %,
(2) polycarbodiimide with a content of greater than or equal to 0.1 wt. % to less than or equal to 0.7 wt. %,
(3) epoxidized copolymer of styrene with acrylic acid ester with a content of greater than or equal to 0.1 wt. % to less than or equal to 0.5 wt. %,
(4) aromatic phosphate ester with a content of greater than or equal to 1 wt. % to less than or equal to 25 wt. %, preferably of greater than or equal to 5 wt. % to less than or equal to 25 wt. % with a phosphate content of greater than 5 wt. % in the aromatic phosphate ester and
(5) optionally additives and/or fillers.

### Substrate Material C (Composition C=to 100 wt. %)

(1) PLA with a content of greater than or equal to 43.8 wt. %, preferably 70 wt. %, to less than or equal to 88.8 wt. %,
(1.1) cellulose, cellulose acetate and/or cellophane with a content of greater than or equal to 10 wt. % to less than or equal to 30 wt. %,
(2) polycarbodiimide with a content of greater than or equal to 0.1 wt. % to less than or equal to 0.7 wt. %,
(3) epoxidized copolymer of styrene with acrylic acid ester with a content of greater than or equal to 0.1 wt. % to less than or equal to 0.5 wt. %,
(4) aromatic phosphate ester with a content of greater than or equal to 1 wt. % to less than or equal to 25 wt. %, preferably of greater than or equal to 5 wt. % to less than or equal to 25 wt. % with a phosphate content of greater than 5 wt. % in the aromatic phosphate ester and
(5) optionally additives and/or fillers.

### Substrate Material D (Composition D=to 100 wt. %)

(1) PLA with a content of greater than or equal to 43.8 wt. %, preferably 70 wt. %, to less than or equal to 88.8 wt. %,
(1.1) PET with a content of greater than or equal to 10 wt. % to less than or equal to 30 wt. %,
(2) polycarbodiimide with a content of greater than or equal to 0.1 wt. % to less than or equal to 0.7 wt. %,
(3) epoxidized copolymer of styrene with acrylic acid ester with a content of greater than or equal to 0.1 wt. % to less than or equal to 0.5 wt. %,
(4) aromatic phosphate ester with a content of greater than or equal to 1 wt. % to less than or equal to 25 wt. %, preferably of greater than or equal to 5 wt. % to less than or equal to 25 wt. % with a phosphate content of greater than 5 wt. % in the aromatic phosphate ester and
(5) optionally additives and/or fillers

Where necessary the substrate according to the invention in the form of a planar element and the substrate material comprising a composition comprising modified polylactic acid for producing the substrate according to the invention includes one or more additives or auxiliary substances selected from
(1) acid scavengers to increase the stability to hydrolysis. This procedure is preferred above all in the case of polyesters having a high starting acid number. Preferred acid scavengers are, in particular, compounds selected from the group consisting of bisoxazoline, polyoxazoline, carbodiimide, polymeric carbodiimide, dicaprolactam, polymeric caprolactam, bisoxazine and polyoxazine,
(2) nucleating agents, such as talc, chalk, carbon black, graphite, calcium or zinc stearate, poly-D-lactic acid, N,N′-ethylene-bis-12-hydroxystearamide, polyglycollic acid, sodium phenylphosphinate, aluminum oxide, silicon dioxide and preferably talc,
(3) lubricants, such as preferably long-chain fatty acids (for example stearic acid or behenic acid), salts thereof (for example Ca or Zn stearate) or montan waxes (mixtures of straight-chain, saturated carboxylic acids having chain lengths of from 28 to 32 C atoms) or salts thereof with alkali or alkaline earth metals, preferably Ca montanate and/or sodium montanate) and low molecular weight polyethylene or polypropylene waxes,
(4) fillers, such as glass fibers,
(5) UV stabilizers, such as various substituted resorcinols, salicylates, benzotriazoles and benzophenones, preferably organic phosphatines, such as, for example, tetrakis(2,4-di-tert-butylphenyl)biphenylene diphosphonite and/or
(6) coloring agents, such as dyestuffs and inorganic pigments, such as ultramarine blue, iron oxide, zinc sulfide and titanium dioxide, furthermore organic pigments, such as phthalocyanines, quinacridones, perylenes and dyestuffs, such as anthraquinones, are added as coloring agents.

The present invention furthermore provides the use of a composition comprising modified polylactic acid as a substrate material for producing the substrate according to the invention, characterized in that the composition comprising modified polylactic acid has a flame resistance according to the UL-94 specification of at least V-1, preferably V-0. The substrate, in particular woven fabric, nonwoven or film, produced accordingly from the substrate material of course has the same flame resistance of at least V-1, preferably V-0.

In the use according to the invention the composition comprising modified polylactic acid has a high temperature resistance, preferably at least the requirement B, further preferably C, particularly preferably D is met.

A substrate according to the invention, in particular the planar element, preferably woven fabric, nonwoven and film, which can be produced from the substrate material described likewise has the same temperature resistance.

In a particular embodiment of the invention the substrate material comprising the composition according to the invention comprising modified polylactic acid is used in the form of
(a) planar elements, including spun, woven and/or fused planar elements, such as nonwovens, films, woven fabric, mesh fabric, nets, textiles and textile tapes and/or
(b) fiber structures, including spun, woven and/or fused fibers, yarns stitched fabric, braided fabric, knitted fabric and filaments.

In particular, the planar element by itself or in combination with at least one fiber structure or exclusively the fiber structure is used for producing a substrate, preferably for producing a substrate of high temperature resistance, resistance to hydrolysis and flame resistance, in particular for planar pressure-sensitive adhesive means, including adhesive tapes and cable winding tapes. Preferably, woven fabric, nonwovens or films are used for producing substrates. Such substrates are employed for further processing into planar pressure-sensitive adhesive means, including adhesive tapes and cable winding tapes, preferably such means for automobile uses.

The invention furthermore provides the use of the substrate described above as a substrate, substrate in adhesive tapes and/or cable winding tapes, in particular substrate in planar pressure-sensitive adhesive means, as a substrate in cable tapes according to LV 312, as a substrate for an adhesive composition, substrate for pressure-sensitive adhesive compositions, as a substrate in articles for identifying objects and components, in particular those in motor vehicles and for identifying electrical equipment, as a substrate in multilayered labels and punched parts, in multilayered laser-markable labels and punched parts, transfer material, a transfer film or release liner, in films, OLEDs, in adhesive tapes as covering material, covering film transfer material and/or release liner. Preferably, the substrate of the abovementioned embodiments is present as a planar element, as a planar element in combination with fiber structures or as a substrate including exclusively fiber structures.

The process for producing an adhesive tape with a substrate according to the invention comprises
(1) presenting the substrate, in particular in the form of a planar element, preferably a nonwoven, woven fabric and/or film, having a high hydrolysis, temperature and flame resistance in the context of the invention,
(2) applying an adhesive composition, in particular a pressure-sensitive adhesive composition, preferably an acrylate adhesive composition suitable for surfaces of high polarity, in the form of at least one layer to at least one of the two surfaces of the substrate, and optionally
(3) covering the adhesive composition with a covering material and/or transfer material, which likewise can be a planar element and/or fiber structure in the context of the invention, and (4) optionally rolling up the single- or double-sided adhesive tape and/or cable winding tape obtained to form a banderole, or producing punched parts.

As a pressure-sensitive adhesive composition, a pressure-sensitive adhesive composition which is the crosslinking product of a polymer composition comprising at least the following components is particularly preferred
(A) at least one polymer component A comprising:
   (i) greater than or equal to 60 wt. % to less than or equal to 80 wt. %, based on the content of polymer component A, of at least one component A1, wherein component A1 comprises:
      (i-a) greater than or equal to 1 wt. % to less than or equal to 15 wt. %, based on the total content of component A1, of at least one monomer a including compounds having at least one ethylenically unsaturated bond, which is in each selected such that the glass transition temperature T_{G} of the corresponding homopolymer from the particular monomer a is at least 0° C.,
         wherein at least a part of the total content of monomer a is present as at least one monomer al including compounds having at least one ethylenically unsaturated bond and at least one carboxylic acid group (—COOH), preferably acrylic acid and/or methacrylic acid with a content of greater than or equal to 3 wt. % to less than or equal to 8 wt. %, based on the total content of component A1 and
      (i-b) greater than or equal to 85 wt. % to less than or equal to 99 wt. %, based on the total content of component A1, of at least one monomer b selected from the group of acrylic acid esters and/or methacrylic acid esters, which is in each selected such that the glass transition temperature T_{G} of the corresponding homopolymer from the particular monomer b is less than or equal to −30° C.,
      wherein the (i-a) at least one monomer a and the (i-b) at least one monomer b are present in total in components A1 (A1=to 100 wt. %) with a content of 100 wt. %,
   (ii) greater than or equal to 20 wt. % to less than or equal to 40 wt. %, based on the content of polymer component A, of at least one resin component A2,
      wherein the (i) at least one component A1 and the (ii) at least one resin component A2 are present in total in polymer component A (A=to 100 wt. %) with a content of 100 wt. % and
(B) at least one crosslinker component B, including covalently crosslinking bi- or polyfunctional compounds,
   wherein the (A) at least one polymer component A and the (B) at least one crosslinker component B are present in total with a content of greater than or equal to 95 wt. % of the total composition of the polymer mass (PM=to 100 wt. %) and
   wherein the surfaces of high polarity include
(I) at least one hydroxyl, carbonyl, carboxyl, SH, NH group and/or at least one ionic group and/or
(II) at least one adsorbed compound capable of migration, containing at least one hydroxyl group.

All known adhesive composition systems can be used. In addition to adhesive compositions based on natural or synthetic rubber, in particular silicone adhesive compositions and polyacrylate adhesive compositions, preferably an acrylate hot melt adhesive composition, can be used. Because of their particular suitability as an adhesive composition for winding tapes for automobile cable looms in view of the freedom from fogging and the outstanding compatibility with PVC and PVC-free conductor insulations, solvent-free acrylate hot melt compositions such as are described in more detail in DE 198 07 752 A1 and in DE 100 11 788 A1 are to be preferred.

The application weight varies preferably in the range between 15 to 200 g/m², further preferably 30 to 120 g/m² (corresponds approximately to a thickness of from 15 to 200 μm, further preferably 30 to 120 μm).

Preferably, the adhesive composition is a pressure-sensitive adhesive composition, that is to say an adhesive composition which already allows a permanent bond with almost all adherend bases under a relatively weak pressing-on pressure and after use can be detached again from the adherend base essentially without residue. A pressure-sensitive adhesive composition has a permanent contact adhesive action at room temperature, that is to say has a sufficiently low viscosity and a high touch tackiness such that it already wets the surface of the particular adherend base under a low pressing-on pressure. The adherability of the adhesive composition is based on its adhesive properties and the re-detachability is based on its cohesive properties.

A suitable adhesive composition is one on an acrylate hot melt basis which has a K value of at least 20, in particular greater than 30 (measured in each case in 1 wt. % strength solution in toluene, 25° C.), obtainable by concentration of a solution of such a composition to a system processable as a hot melt.

The K value (according to FIKENTSCHER) is a measure of the average molecular size of highly polymeric substances. The determination of the viscosity of polymers by a capillary viscometer is carried out in accordance with DIN EN ISO 1628-1:2009.

For the measurement, one percent strength (1 g/100 ml) solutions of the polymer in toluene are prepared at 25° C. and measured using the corresponding DIN Ubbelohde viscometer in accordance with ISO 3105:1994, table B.9.

The concentration can take place in appropriately equipped tanks or extruders, in particular for the accompanying degassing a degassing extruder is preferred.

Such an adhesive composition is disclosed in DE 43 13 008 C1. In an intermediate step, the solvent is removed completely from these acrylate compositions prepared by this route.

In addition, further readily volatile constituents are thereby removed. After coating from the melt, these compositions have only low contents of volatile constituents. All the monomers/recipes claimed in the abovementioned patent can thus be adopted.

The solution of the composition can comprise 5 to 80 wt. %, in particular 30 to 70 wt. % of solvent.

Preferably, commercially available solvents are employed, in particular low-boiling hydrocarbons, ketones, alcohols and/or esters.

Further preferably, single-screw, twin-screw or multi-screw extruders having one or in particular two or more degassing units are employed.

Benzoin derivatives can be polymerized into the adhesive composition on an acrylate hot melt basis, thus, for example, benzoin acrylate or benzoin methacrylate, acrylic acid esters or methacrylic acid esters. Such benzoin derivatives are described in EP 0 578 151 A.

The adhesive composition on an acrylate hot melt basis can be crosslinked by UV. However, other types of crosslinking are also possible, for example crosslinking by an electron beam.

In a further preferred embodiment copolymers of (meth)acrylic acid and esters thereof having 1 to 25 C atoms, maleic, fumaric and/or itaconic acid and/or esters thereof, substituted (meth)acrylamides, maleic anhydride and other vinyl compounds, such as vinyl esters, in particular vinyl acetate, vinyl alcohols and/or vinyl ethers, are employed as self-adhesive compositions.

The residual solvent content should be less than 1 wt. %.

An adhesive composition which manifests itself as particularly suitable is an acrylate hot melt adhesive composition such as is marketed by BASF under the name acResin, in particular acResin A 260 UV. This adhesive composition having a low K value obtains its properties appropriate for the use by a concluding crosslinking initiated by radiation chemistry.

Further outstandingly suitable adhesive compositions are described in the documents DE 10 2011 075 152 A1, DE 10 2011 075 156 A1, DE 10 2011 075 159 A1 and DE 10 2011 075 160 A1.

Preferably, the adhesive composition is applied over the entire area of the substrate.

The adhesive composition can be applied in the longitudinal direction of the adhesive tape in the form of a strip which has a smaller width than the substrate material of the adhesive tape.

In an advantageous embodiment the coated strip has a width of from 10 to 80% of the width of the substrate material. The use of strips having a coating of from 20 to 50% of the width of the substrate material particularly preferably takes place.

Depending on the case in use, several parallel strips of the adhesive can also be coated on to the substrate material.

The position of the strip on the substrate can be freely chosen, an arrangement directly on one of the edges of the substrate being preferred.

Furthermore, two adhesive strips can be provided, and in particular one adhesive strip on the upper side of the substrate material and one adhesive strip on the under-side of the substrate material, wherein the two adhesive strips are preferably arranged on opposite longitudinal edges. According to one variant the two adhesive strips are arranged on one and the same longitudinal edge.

Preferably, the adhesive strip or strips in each case end flush with the longitudinal edge or edges of the substrate material.

At least one strip of a covering which extends or extend in the longitudinal direction of the adhesive tape and which covers or cover between 20% and 90% of the adhesive coating can be provided on the adhesive coating of the substrate.

Preferably, the strip covers in total between 50% and 80% of the adhesive coating. The degree of covering is chosen as a function of the use and of the diameter of the cable loom.

The percentage figures stated relate to the width of the strip of the covering with respect to the width of the substrate.

According to a preferred embodiment of the invention exactly one strip of the covering is present on the adhesive coating.

The position of the strip on the adhesive coating can be freely chosen, wherein an arrangement directly on one of the longitudinal edges of the substrate is preferred. In this manner an adhesive strip which extends in the longitudinal direction of the adhesive tape and which seals with the other longitudinal edge of the substrate results.

If the adhesive tape is employed for sheathing a cable harness by leading the adhesive tape around the cable harness in a helical movement, the enveloping of the cable harness can take place such that the adhesive composition of the adhesive tape is stuck only on to the adhesive tape itself, while the goods do not come into contact with any adhesive.

The cable harness sheathed in this way has a very high flexibility due to the absence of fixing to the cable by any adhesive. Its bendability during installation—precisely also in narrow passages or sharp bends—is thus increased significantly.

If a certain fixing of the adhesive tape on the goods is desired, the sheathing can be effected such that the adhesive strip is stuck partly on the adhesive tape itself and otherwise partly on the goods.

According to another advantageous embodiment the strip is applied centrally to the adhesive coating, so that two adhesive strips extending on the longitudinal edges of the substrate in the longitudinal direction of the adhesive tape result.

For reliable and economical application of the adhesive tape around the cable harness in the said helical movement and against slipping of the resulting protective envelope, the two adhesive strips present in each case on the longitudinal edges of the adhesive tape are advantageous, especially if one, which is usually narrower than the second strip, serves as a fixing aid and the second, wider strip serves as a closure. In this manner the adhesive tape is stuck on the cable such that the cable loom is secured against slipping and nevertheless is flexible in configuration.

In addition, there are embodiments in which more than one strip of the covering are applied to the adhesive coating. If only one strip is referred to, the person skilled in the art interprets this as meaning that it is entirely possible for several strips also to cover the adhesive coating simultaneously.

The preparation and processing of the adhesive compositions can take place from solution, dispersion and from the melt. Preferred preparation and processing processes take place from solution and from the melt. Production of the adhesive composition from the melt is particularly preferred, in which in particular batch processes or continuous processes can be employed. Continuous production of the pressure-sensitive adhesive compositions with the aid of an extruder is particularly advantageous.

The adhesive compositions prepared in this way can then be applied to the substrate by the generally known processes. In the case of processing from the melt, these application processes can be via a nozzle or a calender.

In the case of processes from solution, coating operations with doctor blades, knives or nozzles are known, to mention only a few.

A transfer of the adhesive composition from an anti-adhesive substrate cloth or release liner to the substrate composite is also possible.

Finally, the adhesive tape can have a covering material, with which the one or the two layers of adhesive composition are covered until used. All the materials listed above in detail are also suitable as covering materials.

Preferably, however, a non-linting material is employed, such as a film of plastic or a well-sized, long-fibred paper.

A reverse side lacquer can be applied to the reverse side of the adhesive tape in order to favorably influence the unrolling properties of the adhesive tape wound to the archimedic spiral. For this, this reverse side lacquer can be treated with silicone compounds or fluorosilicone compounds and with polyvinylstearyl carbamate, polyethyleneiminestearylcarbamide or organofluorine compounds as substances having an abhesive/dehesive action. A foam coating on the reverse side of the adhesive tape is optionally to be found under the reverse side lacquer or alternatively to this.

The adhesive tape according to the invention can be provided in fixed lengths, such as, for example, as meter goods, or as continuous goods on rolls (archimedic spirals). For use, in the latter case cutting of the goods into variable lengths by knives, scissors or dispensers and the like is possible, or a manual processability without aids.

Furthermore, the adhesive tape can have one or more lines of weakness substantially at right angles to the running direction, so that the adhesive tape is easier to tear by hand. In order to render possible particularly simple working for the user, the lines of weakness are aligned and/or arranged at regular distances at right angles to the running direction of the adhesive tape.

The adhesive tape can be separated particularly easily if the lines of weakness are configured in the form of perforations.

Edges between the individual sections which are very lint-free can be achieved in this manner, that is to say an undesirable fraying is avoided.

The lines of weakness can be particularly advantageously generated discontinuously with planishers or transversely running perforation wheels and continuously using rotary systems, such as porcupine rollers or punching rollers, optionally using a counter-roller (Vulkollan roller), which form the counter-wheel during cutting.

Further possibilities are cutting technologies operating intermittently in a controlled manner, such as, for example, the use of lasers, ultrasound, high pressure water jets etc. If some of the energy is introduced into the substrate material as heat, as during laser or ultrasound cutting, the fibers can fuse in the cutting region so that troublesome fraying is to the greatest extent avoided and clearly defined cut edges are obtained. The latter processes are also suitable for achieving specific cut edge geometries, for example concavely or convexly shaped cut edges.

The height of the spike or knife on the punching rollers is preferably 150% of the thickness of the adhesive tape.

The hole-bar ratio of the perforation, that is to say how many millimeters hold the material together (“bridge”), how many millimeters are separated, determines how easily in particular the fibers of the substrate material can be torn. Furthermore, in the end this ratio also influences how lint-free the torn-off edge can be obtained. Preferably, the bar width is approximately 2 mm and the cut width between the bars is approximately 10 mm, that is to say bars 2 mm wide alternate with incisions of 10 mm. The hole-bar ratio accordingly is preferably 2:10. A sufficiently low tearing off force can be achieved with this weakening of the material.

If flame resistance of the adhesive tape described is desired, this can be achieved by adding flameproofing agents to the substrate and/or the adhesive composition. These can be organobromine compounds, if required with synergists such as antimony trioxide, but in view of the absence of halogen in the adhesive tape red phosphorus, organophosphorus, mineral or intumescent compounds, such as ammonium polyphosphate, by themselves or in combination with synergists, are preferably used.

According to a preferred embodiment the width of the adhesive tape is between 9 and 38 mm.

Furthermore, it is advantageously suitable for sheathing elongated goods, such as, in particular, cable looms in motor vehicles, wherein the adhesive tape is led around the elongated goods in a helical line or the elongated goods are enveloped by the tape in the axial direction.

Finally, the inventive idea also includes elongated goods sheathed with an adhesive tape according to the invention. Preferably, the elongated goods are a cable loom.

On the basis of the outstanding suitability of the adhesive tape, it can be used in a sheathing which comprises a covering, in which at least in one edge region of the covering of the self-adhesive adhesive tape is present, which is stuck on the covering such that the adhesive tape extends over one of the longitudinal edges of the covering, and indeed preferably in an edge region which is narrow compared with the width of the covering.

Such a product and optimized embodiments thereof are disclosed in EP 1 312 097 A1. EP 1 300 452 A2, DE 102 29 527 A1 and WO 2006 108 871 A1 disclose further developments for which the adhesive tape according to the invention is likewise very particularly suitable. The adhesive tape according to the invention can likewise be used in a process such as is disclosed in EP 1 367 608 A2.

Finally, EP 1 315 781 A1 and DE 103 29 994 A1 describe embodiments of adhesive tapes such as are also possible for the adhesive tape according to the invention.

Finally, the inventive idea also includes elongated goods sheathed with an adhesive tape according to the invention. Preferably, the elongated goods are a cable loom, further preferably in an automobile.

The invention likewise provides an adhesive tape obtainable by the process described above and obtainable from the substrate material based on a composition comprising a modified polylactic acid. Preferably, the adhesive tape obtainable by the process described above is a flame-resistant, temperature-resistant and hydrolysis-resistant adhesive tape, in particular cable winding tape, including a substrate according to the invention. By the particular combination of the compound containing a carbodiimide group, the phosphorus-containing compound and the compound having at least one epoxide group in combination with an aromatic and/or ester group, the threefold protection of the adhesive tape, in particular of the cable winding tape for automobile uses, is achieved. By variation of the fiber mixtures from different polymers, in particular polyester, for producing the substrate, the requirements can be matched to the intended use. In particular, by using the preferably biobased polylactic acid as the polyester and further biodegradable polyesters, a protection of natural resources can be achieved. In order to increase a protection of the environment, further components of an adhesive tape, such as, for example, a biodegradable pressure-sensitive adhesive composition, can be combined.

The adhesive tape is particularly suitable for use in regions of high humidity. In particular in combination with the abovementioned pressure-sensitive adhesive composition having a high content of carboxylic acid groups of the acrylic acid used. In the substrate the use of compounds containing an epoxide group in the composition comprising polylactic acid leads to improved resistance to hydrolysis. Splitting of the substrate material due to the influence of water is thus prevented. In particular splitting by compounds capable of migration containing hydroxyl groups is minimized or prevented. If an adhesive tape or cable winding tape adheres to a surface in regions of high humidity, compounds containing hydroxyl groups can penetrate from the surrounding medium into the substrate material by diffusion. The high polarity of the compounds in the composition comprising modified polylactic acid promotes interactions with such compounds capable of migration. The person skilled in the art would expect that reactive groups, in particular groups containing oxygen, such as hydroxyl groups, carboxylic acid groups, epoxide groups and ester groups, which are involved in such hydrogen bridge bonds with the compounds capable of migration containing hydroxyl groups, would lead to cleavage of the crosslinkings of the substrate material, in particular of the branchings between the polyester molecules in the substrate material. Nevertheless, due to the increased number of such reactive groups in the substrate material according to the invention, in particular due to the compounds containing epoxide groups in the composition, a strong network is achieved between the polyester molecules, preferably polylactic acid molecules. A softening of the substrate material and therefore of the substrate is thereby prevented. As a result the substrate material according to the invention and therefore the substrate according to the invention and in the end the adhesive tape comprising the substrate have an outstanding resistance to hydrolysis.

A further aspect of the present invention is the use of the adhesive tape, preferably comprising the substrate according to the invention in the form of a planar element, preferably as a woven fabric, nonwoven or film, of the type described for protection from abrasion, for protection of cable winding tapes from abrasion, from moisture and/or wetness, from high temperatures, from flames or fire, for damping noise, insulation, sheathing, sheathing of cables, bundling, bundling of cables, positioning and fixing of elongated goods, such as electrical leads, including cables and wires according to LV 312, wherein the adhesive tape is led around the elongated goods in a helical line.

The general expression “adhesive tape” in the context of this invention includes all planar structures, such as films or film sections extended in two dimensions, tapes having an extended length and limited width, tape sections and the like, finally also punched parts or labels.

In particular, the expression “adhesive tape” includes single- or double-sided adhesive tapes. These are preferably selected from the group including self-adhesive products, single-sided adhesive tapes (woven fabric adhesive tapes), carpet-laying tapes, structural adhesive tapes, covering adhesive tapes, transfer adhesive tapes (transfer tape), insulating adhesive tapes and surface protection films.

### Test Methods

The measurements in this context take place in accordance with the following standards:

Weights Per Unit Area of the Woven Fabric and the Adhesive Composition Coating in Accordance with DIN EN ISO 2286-1
Yarn weight in accordance with DIN 53830 P 3
Thread count in accordance with DIN EN 1049 part 2
Adhesive strength in accordance with DIN EN 1939
Thickness of the woven fabric and adhesive tapes in accordance with DIN EN 1942
Tensile strength: DIN 53455-7-5 in the longitudinal direction
Elongation at break: DIN 53455-7-5 in the longitudinal direction

### Molecular Weights

The determination of the average molecular weight M_{W}, of the number-average molecular weight M_{N} and of the polydispersity D is carried out by means of gel permeation chromatography (GPC). THF with 0.1 vol. % of trifluoroacetic acid was employed as the eluent. The measurement was performed at 25° C. PSS-SDV, 5 μm, 10³ Å, ID 8.0 mm×50 mm was used as the precolumn. The columns PSS-SDV, 5 μm, 10³ Å, 10⁵ Å and 10⁶ Å of in each case ID 8.0 mm×300 mm were employed for the separation. The sample concentration was 4 g/l, the flow rate was 1.0 ml per minute. Measurement was made against PMMA standards.

The weight-average molecular weight M_{W} and the number-average molecular weight M_{N} are determined here by means of gel permeation chromatography (GPC). THF with 0.1 vol. % of trifluoroacetic acid is employed as the eluent. The measurement is performed at 25° C. PSS-SDV, 5μ, 10³ Å, ID 8.0 mm×50 mm is used as the precolumn. The columns PSS-SDV, 5μ, 10³ Å and 10⁵ Å and 10⁶ Å of in each case ID 8.0 mm×300 mm are employed for the separation. The sample concentration is 4 g/l, the flow rate is 1.0 ml per minute. Measurement is made against PMMA standards (μ=μm; 1 Å=10⁻¹⁰ m).

### Combustibility UL 94 V

This test method is employed in the determination of combustibility classes UL 94 V-0, V-1, V-2.

With flaming several times, both the afterburn and afterglow time and the burning dripping of the test specimens are evaluated here.

The pretreatment of the samples is as follows:

2 days/23° C./50% rel. humidity.
7 days/70° C./hot air oven.
Flaming with a 20 mm high Tirrill burner flame
Flaming time 2×10 s

The second flaming time starts as soon as the ignited sample is extinguished; in the case of non-ignited samples immediately thereafter.

Combustibility class UL 94 V

| | V-0 | V-1 | V-2 |
|---|---|---|---|
| Afterburn time after flaming (s) | ≦10 | ≦30 | ≦30 |
| Sum of all the afterburn times (s) (10 flamings) | ≦50 | ≦250 | ≦250 |
| Afterburn time and afterglow of the samples | ≦30 | ≦60 | ≦60 |
| after the second flaming (s) | | | |
| Burning dripping (ignition of the cotton | no | no | yes |
| wadding) | | | |
| Complete burning of the sample | no | no | no |

### Melt Flow Index

The melt flow index is tested in accordance with ISO 1133 under 2.16 kg and expressed in g/10 min. The test temperature is 190° C.

### Softening Point

The softening temperature of copolymers, hard and soft blocks and non-cured reactive resins is determined calorimetrically via differential scanning calorimetry (DSC) in accordance with DIN 53765:1994-03. The heating up curves run with a heating rate of 10 K/min. The samples are measured in Al crucibles with a perforated lid under a nitrogen atmosphere. The second heating up curve is evaluated. In the case of amorphous substances glass transition temperatures occur, in the case of (semi)crystalline substances melting temperatures. A glass transition is detectable as a step in the thermogram. The glass transition temperature is evaluated as the middle point of this step. A melting temperature is detectable as a peak in the thermogram. That temperature at which the highest heat effect occurs is noted as the melting temperature.

The invention is to be explained in more detail in the following with the aid of examples, without the intention being to limit the invention in any manner with these.

A woven fabric and a nonwoven are investigated in more detail in the following.

### Example 1

### Woven Fabric Construction

100 parts by wt. of Biofront™ J20 (PLA stereocomplex from Teijin) are dried and compounded on a twin-screw extruder with 5 parts by wt. of Reofos™ 65 (isopropylated triaryl phosphate from Great Lakes) and 2 parts by wt. of Stabaxol™ P200 (carbodiimide of Rheinchemie) and the mixture is granulated and dried. The granules are spun to fibers having the following properties:

The DSC melting point of the fibers is 218° C.

Fiber 2 dtex
Tensile strength: 35 cN/tex
Elongation at break: 50%. These are processed to a woven fabric.

Finally, coating is carried out with an acrylate hot melt adhesive composition (acResin A 260 UV from BASF).

TABLE 1
Woven fabric construction

| | (I) | |
|---|---|---|
| Weight per unit area | 130 | g/m² |
| Thread count longitudinal (warp) | 48/cm | |
| Thread weight longitudinal | 167 | dtex |
| Thread count transverse (weft) | 23/cm | |
| Thread weight transverse | 167 | dtex |

| | |
|---|---|
| Temperature stability | D |

TABLE 2
Adhesive tape properties

| | (I) | |
|---|---|---|
| Adhesive type | acrylate | |
| Adhesive application | 95 | g/m² |
| Total thickness | 0.26 | mm |

| | |
|---|---|
| Adhesive strength on steel | 5.0 to 7.0 N/cm |

### Example 2

### Nonwoven Constructions

100 parts by wt. of Ingeo (PLA from NatureWorks) are dried and compounded on a twin-screw extruder with 5 parts by wt. of Fyrolflex™ RDP (resorcinol phosphate oligomer from Akzonobel) and 1 part by wt. of TCC™ (carbodiimide from Teijin, see US 2011/0237755 A1) and the mixture is granulated and dried. The compound is then processed in the spunbonding process to a nonwoven weighing 150 g/m² and bonded by needle punching.

The DSC melting point of the fibers is 150° C.

Finally, coating is carried out with an acrylate hot melt adhesive composition (acResin A 260 UV from BASF).

### Essential Features:

Temperature class C (LV 312)
Very good resistance to media
Very good ease of tearing by hand

1. A substrate in the form of a planar element including a composition comprising modified polylactic acid, including the components
(1) at least one (co)polymer based on at least one lactic acid,
(2) at least one compound including at least one carbodiimide group,
(3) optionally at least one compound having at least one epoxide group, additionally containing at least one ester group and/or at least one aromatic group,
(4) at least one phosphorus-containing compound and
(5) optionally additives and/or fillers.

2. The substrate as claimed in claim 1, wherein
in the composition the following components are in each case present with a content, based on the total content of the composition comprising polylactic acid (to 100 wt. %), to the extent of
(1) greater than or equal to 35 wt. %, optionally 25 wt. %, to less than or equal to 98.98 wt. % of the at least one (co)polymer based on at least one monomer and/or dimer of lactic acid,
(2) greater than or equal to 0.01 wt. % to less than or equal to 20 wt. % of the at least one compound containing a carbodiimide group,
(3) optionally greater than or equal to 0.1 wt. % to less than or equal to 10 wt. % of the at least one compound having at least one epoxide group, additionally containing at least one ester group and/or at least one aromatic group, and
(4) greater than or equal to 1 wt. % to less than or equal to 35 wt. % of the at least one phosphorus-containing compound and
(5) greater than or equal to 0 wt. % to less than or equal to 10 wt. % of additives and/or fillers.

3. The substrate as claimed in claim 1, wherein
(1) the at least one compound based on lactic acid is a monomer and/or dimer of lactic acid selected from the group consisting of L-lactic acid, D-lactic acid, (S,S)-lactide, (R,R)-lactide, (meso)-lactide and mixtures of at least two thereof.

4. The substrate as claimed in claim 1, wherein
(3) the at least one compound having at least one epoxide group, additionally containing at least one ester group and/or at least one aromatic group, is selected from the group consisting of
(3.1) at least one epoxidized copolymer, including styrene and acrylic acid ester, styrene and methacrylic acid ester or mixtures of the two copolymers, optionally containing at least one glycidyl acrylate and/or glycidyl methacrylate as the epoxide group,
(3.2) at least one epoxidized fatty acid ester, including (i) natural oils selected from the group consisting of olive oil, linseed oil, palm oil, groundnut oil, coconut oil, tung oil, rapeseed oil, castor oil and cod liver oil, and fatty acids thereof present, and (ii) fatty acid esters, including esters of saturated or unsaturated aliphatic carboxylic acids having 10 to 40 C atoms.

5. The substrate as claimed in claim 1, wherein
(4) the at least one phosphorus-containing compound is selected from the group consisting of
(4.2) aliphatic esters of the phosphoric acid, selected from the group consisting of tris(chloroethyl) phosphate (TCEP), tris(chloropropyl) phosphate (TCPP), tris(dichloroisopropyl) phosphate (TDCPP) and derivatives thereof, and aromatic esters of phosphoric acid, selected from the group consisting of triphenyl phosphate (TPP), tris(2-ethylhexyl) phosphate (TEHP), tricresyl phosphate (TKP), isopropylated triphenyl phosphate (ITP), including mono-, bis- and tris(isopropylphenyl) phosphate, resorcinol bis(diphenyl)phosphate (RDP) and bisphenol A bis(diphenyl)phosphate (BDP), and derivatives and mixtures of at least two of the compounds mentioned.

6. The substrate as claimed in claim 1, wherein
the planar element includes (a) spun, woven and/or fused planar elements, selected from the group consisting of nonwovens, films, woven fabric, mesh fabric, nets, textiles and textile tapes and/or (b) spun, woven and/or fused fiber structures, selected from the group consisting of fibers, yarns, stitched fabric, braided fabric, knitted fabric and filaments.

7. The substrate as claimed in claim 1, having
a flame resistance in accordance with the combustibility class UL 94 V specification of at least V-1.

8. The substrate as claimed in claim 1, wherein
the temperature resistance of the substrate meets at least the requirement B according to LV 312.

9. The substrate as claimed in claim 1, wherein
the (1) (co)polymer is a biobased polymer.

10. The substrate as claimed in claim 1, wherein
the planar element in the form of a woven fabric, nonwoven or film, comprises a biocide.

11. A method for producing a substrate including the following components
(1) at least one (co)polymer based on at least one lactic acid,
(2) at least one compound including at least one carbodiimide group,
(3) optionally at least one compound having at least one epoxide group, additionally containing at least one ester group and/or at least one aromatic group,
(4) at least one phosphorus-containing compound and
(5) optionally additives and/or fillers
wherein said substrate is produced from a composition comprising modified polylactic acid as a textile substrate material.

12. The method of claim 11, wherein
in the composition the following components are in each case present with a content, based on the total content of the composition comprising polylactic acid (to 100 wt. %), to the extent of
(1) 35 wt. %, optionally 25 wt. %, to less than or equal to 98.89 wt. % of the at least one (co)polymer based on at least one lactic acid,
(2) greater than or equal to 0.01 wt. % to less than or equal to 20 wt. % of the at least one compound containing a carbodiimide group,
(3) greater than or equal to 0.1 wt. % to less than or equal to 10 wt. % of the at least one compound having at least one epoxide group, additionally containing at least one ester group and/or at least one aromatic group, and
(4) greater than or equal to 1 wt. % to less than or equal to 35 wt. % of the at least one phosphorus-containing compound, and
(5) greater than or equal to 0 wt. % to less than or equal to 10 wt. % of additives and/or fillers.

13. The method of claim 11, wherein
the (1) at least one biodegradable (co)polymer is a polyester based on (a) at least one monomer and/or dimer of lactic acid selected from the group consisting of L-lactic acid, D-lactic acid, (S,S)-lactide, (R,R)-lactide, (meso)-lactide and mixtures of at least two of the same.

14. The method of claim 11, wherein
the composition comprising modified polylactic acid includes as at least one further component (1.1) at least one further polymer selected from the group consisting of
(a) polymers, including polyethylene terephthalate (PET), polytrimethylene terephthalate (PTT), polybutylene terephthalate (PBT), polyamide (PA), polyurethane (PU), polybutyl succinate (PBS), polycaprolactone (PCL) and starch and/or
b) copolymers based on at least one fatty acid selected from the group consisting of polyhydroxybutyrate (PHB), polyhydroxyvalerate (PHV), polyhydroxybutyrate-co-hydroxyvalerates (PHBV) and polyhydroxybutyrate-co-hydroxyhexanoate (PHBH).

15. The method of claim 11, wherein
the composition comprising modified polylactic acid has a flame resistance in accordance with the combustibility class UL 94 V specification of at least V-1.

16. The method of claim 11, wherein
the composition comprising modified polylactic acid meets at least the requirement B according to LV 312.

17. The method of claim 11, wherein
the composition comprising modified polylactic acid is present as a substrate material in the form of
(a) nonwovens, films, woven fabric, mesh fabric, nets, textiles and textile tapes and/or
(b) spun, woven and/or fused fibers, yarns, stitched fabric, braided fabric, knitted fabric and filaments.

18. A substrate of claim 1, as a substrate in adhesive tapes and/or cable winding tapes, as a substrate in cable tapes according to LV 312, as a substrate for an adhesive composition, substrate for pressure-sensitive adhesive compositions, as a substrate in articles for identifying objects and components, as a substrate in multilayered labels and punched parts, in multilayered laser-markable labels and punched parts, transfer material, a transfer film or release liner, in films, OLEDs, in adhesive tapes as covering material, covering film, transfer material and/or release liner.

19. A process for producing an adhesive tape, comprising
(1) presenting the substrate as claimed in claim 1,
(2) applying an adhesive composition in the form of a layer to at least one surface thereof and optionally
(3) covering the adhesive composition with a covering material and/or transfer material.

20. An adhesive tape obtainable by the process as claimed in claim 19.

21. A method for protection of cable winding tapes from abrasion, from moisture and/or wetness, from high temperatures, from flames or fire, for damping noise, insulation, sheathing, sheathing of cables, bundling, bundling of cables, positioning and fixing of elongated goods, such as electrical leads, including cables and wires according to LV 312, wherein the adhesive tape of claim 20 is led around the elongated goods in a helical line.
